(19) United States
(12) Patent Application Publication
(10) Pub. No.: US 2006/0178209 A1
(43) Pub. Date: Aug. 10, 2006

(54) Electronic gaming using speech-recognition

(76) Inventor: Larry M. Shultz, Beverly Hills, CA (US)

Correspondence Address: Crutsinger & Booth LLC;Thanksgiving Tower, Suite 1950, 1601 Elm Street, Dallas, TX, 75201-4744, US

(21) Appl. No.: 11/089,573

(22) Filed: Jun. 16, 2004

(51) Int. Cl. G06F 19/00

(52) U.S. Cl. 463/28

(57) ABSTRACT

In an exemplary embodiment, a system for parimutuel gaming includes a tote system, a gateway, and at least one voice recognition unit and video or visual-graphic server. Each voice recognition unit is communicatably connected to a public telephone network capable of displaying accompanying video or visual-graphic images, and is communicatably connected to the tote bettor by bettor speech utterances, to convert the bettor speech utterances into commands, to transmit the commands to the tote system through the gateway, to receive responses from the tote system to said commands, to convert the responses to audio messages, and to transmit the audio messages to the bettor along with the video or visual-graphic images. The system also includes a first high speed network communicatably connecting the tote system, gateway and video/visual-graphic server; and a second high speed network communicatably connecting the gateway and each voice recognition unit with the video/visual-graphic server. The system may be configured also for sport book betting of any type sports event, including but not limited to betting on boxing matches, baseball, football, basketball and soccer games with concomitant visual display of the sports events on a bettor's handheld gaming device or cellular phone capable of displaying video or visual-graphic images of the games being bet on. The system may be configured also for cellular phone-based playing of electronic casino-type games, including but not limited to video-slots, video-poker, video-blackjack, video-roulette, video-keno or other type electronic games that can be displayed on a bettor's handheld gaming device or cellular phone capable of displaying video or visual-graphic images of the game being played.

### CROSS-REFERENCE TO RELATED APPLICATION

Not applicable

### STATEMENT REGARDING FEDERALLY SPONSORED RESEARCH OR DEVELOPMENT

Not applicable

### REFERENCE TO MICROFICHE APPENDIX

Not applicable

### BACKGROUND OF THE INVENTION

The present invention is generally related to handheld gaming devices and more specifically to a cellular phone-based gaming device which is capable of displaying video or video-graphic images that enables parimutuel betting on events such as dog races, horse races, or jai alai games and the presentation of such races in video or visual-graphic format on the handheld gaming or cellular phone-based device.

Parimutuel racetrack systems, known as “totalisators” or “tote systems” commonly offer the ability for a racetrack patron to open a financial account and deposit funds in the account for the purposes of placing wagers. The cost of a wager is debited from the account balance. Winning wager proceeds are credited to the account balance. Account wagers are generally, but not specifically, placed by the patron using a telephone to communicate the wager to a terminal operator. The terminal operator accesses the account housed in the tote system to place the wager on behalf of the patron.

Although the above-described method provides the racing patron with an elevated level of convenience, over the years, the racing industry has seen an increase in labor costs for terminal operators while experiencing a reduction in revenue because of gaming competition. Racetrack owners would like to maintain the level of convenience for patrons while reducing the racetrack operating costs.

It would then be desirable to provide an automated telephone-based account wagering device which incorporates the services of a terminal operator without requiring the presence of a terminal operator and then using Internet-based or cellular phone-based networks to transmit video or visual-graphic data displaying the race or short visual highlight “clips” of the race on the handheld or cellular phone-based gaming device.

Known automated telephone account betting devices employ the process of prompting the patron for a wager component and waiting for the patron to respond by touching one or several keys on a touch tone telephone to signal the patron's choice. This type of automated telephone account betting device is known as a “touch tone” betting system. This type of system tends to be slow and confusing because the patron must wait for the device to direct the patron as to which wager component is being collected.

It would be desirable to improve the interface between the patron and the automated device such that the patron may speak to the device using natural language and have the device recognize the speech utterances and take the appropriate actions with accompanying video or visual-graphic images representing the results of actions taken. An automated speech recognition telephone betting device with cellular phone-based video or visual-graphic displays would improve the patron device interface by eliminating the need for touch tone telephones and more closely emulating the terminal operator. The automated speech recognition telephone betting device would further reduce operating costs at racetracks by increasing transaction rates and thereby reducing the number of telephone lines employed to collect the same number of transactions per hour as collected by touch tone devices.

### BRIEF SUMMARY OF THE INVENTION

In one aspect the present invention is a cellular phone-based wagering device which enables telephone account wagering without terminal operators. The device, in one embodiment, includes a plurality of telephone lines. Many devices may be connected to a single tote system. The automated speech recognition telephone betting device is a multi-function device which enables the patron to open the account for betting, enter a wager, review past wagers, retrieve information, both in audio and video or visual-graphic format, about the racing products being offered on the tote system, and close the account when the patron hangs up the telephone. The device is a computer system with streaming video or visual-graphic serving capabilities configured to manage the entire telephone conversation with the patron. For example, the device answers the telephones, greets the patrons with an audio and video/visual-graphic message on the handheld display, prompts the patrons as to available options with another audio and video/visual-graphic message, listens to patrons' speech utterances, converts the patrons' speech utterances into commands, transmits the commands to the tote system, receives responses to the commands from the tote system, and converts the responses to audio messages for the patrons to see on their handheld display.

Generally, and in operation, the device will present audio and video/visual-graphic messages to relate command options and process the patron-spoken utterances to carry out those commands. At any time during the telephone call, the patron may speak the word “operator” and be referred to a terminal operator. Also, at any time during the telephone call, the patron may speak the word “help” and receive context sensitive audio and video/visual-graphic messages relating to how to proceed with the conversation. The patron selects from an audio or video/visual-graphic menu to place a bet, review previous bets, or review racing information. To place a bet, the patron speaks “place a bet”. The patron then speaks each wager component as prompted by the device in audio or video/visual-graphic format. Alternatively, the patron elects to speak the entire bet in a natural language utterance. The patron speech is converted to a bet command and forwarded to the tote system for validation. To review previous bets, the patron speaks “review bets,” and the device provides audio and video/visual-graphic messages detailing the bets made during this telephone call reciting the most recent bet first and the first bet last. To review racing information the patron says “racing information” after opening the account. The device presents an audio or video/visual-graphic message asking the patron to select “Win Odds”, “Previous Results”, or “Scratched Runners”. The patron speaks the racing information option to be processed. To hear or see in video/visual-graphic format on the handheld display the Win Odds for a specific race, the patron speaks the track name and race number to be queried. The win odds command is sent to the tote system, and it responds by returning the win odds for each selection in the race. The device will present an audio or video/visual-graphic message to the patron detailing the win odds for the requested race. To hear the results of a previous race, the patron speaks the track name and the requested race. The results command is sent to the tote system, and it responds by returning a list of results, including playback of a race, in audio or video/visual-graphic format Each result in the list of results consists of a selection, a bet type, and a price. For example, Horse 1, Win, paid $5.00. Each result in the result list is presented to the patron as an audio or video/visual-graphic message, To hear the scratched runners for a specified track, the patron speaks the track name. The scratched runner command is sent to the tote system, and it responds by returning a list of scratched runners by race in audio or video/visual-graphic format. For example, race 1, 3 is scratched, race 2, no scratches. The list of scratched runners by race is presented to the patron as an audio or video/visual-graphic message,

As explained above, one aspect of the present invention is to enable parimutuel account wager through the use of speech recognition with accompanying video/visual-graphic display of the race or race results. No known wagering device places wagers, reviews wagers, or reviews racing information by use of speech commands with accompanying video/visual-graphic display or the race or race results.

### BRIEF DESCRIPTION OF THE DRAWINGS

FIG. 1 is a block diagram of the wagering system.

### DETAILED DESCRIPTION OF THE INVENTION

Set forth below is a detailed description of an exemplary embodiment of a wagering system. Many variations of such system are possible, whether for parimutuel racing, sports book betting or electronic Casino game wagering. For example, the present invention is not limited to being practiced in connection with the system architecture described below, and many other system architectures could be utilized.

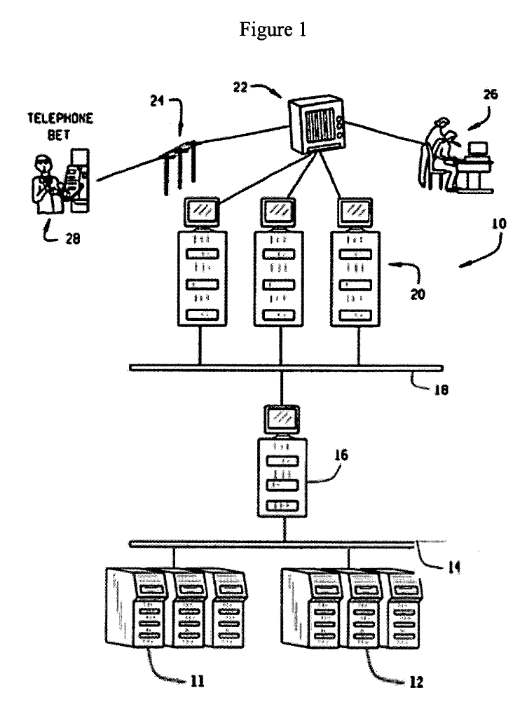

FIG. 1 is a block diagram of a wagering system 10 which includes a tote system 12, a video/visual-graphic game server 11, coupled by a high speed network 14, for example, a “100BaseT Eithernet” network to a gateway 16. A separate high speed network 18, for example, a “100BaseT Eithernet” network couples a plurality of voice recognition units 20 and gateway 16. Voice recognition units 20 are connected to a local telephone switch 22 by a high speed telecommunication circuit, for example, a “T1 connection.” Local telephone switch 22 is connected to a public switching telephone network (PSTN) 24 by a plurality of high speed telecommunication circuits, for example, “T1 connections.” Local telephone switch 22 is also connected to a plurality of terminal operators 26, using individual telephone circuits and telephones PSTN 24, allows a plurality of individual telephone account bettors 28, to connect to the local telephone switch 22, using public telephone circuits.

Tote system 12, video/visual-graphic game server 11, gateway 16, and voice recognition units 20, for example, may be business file server computers commercially available from Compaq Computer Corporation, Houston, Tex. 77269-2000. Local telephone switch 22, for example, may be a telephone switch commercially available from Rolm, A Siemens Company, 4900 Old Ironsides Drive, Santa Clara, Calif. 95052-8075. Voice recognition units 20 include commercially available telephonic interface devices available, for example, from Dialogic Corporation, 1515 Route 10, Parsippany, N.J. 07054-4596. Voice recognition units 20 also contain software to perform speech recognition. Such software is commercially available, for example, from speech Works International, 695 Atlantic Avenue, Boston, Mass. 02111.

Video/visual-graphic server 11 includes multiple video/visual-graphic servers that transmit the visual images accompanying the audio messages that are detailing bets and bet results. The visual images sent by video-graphic server 11 to telephone bettor handheld gaming devices and cellular phones may include still-frame, video or other moving graphical images of an actual race, sports event or electronic casino game.

In the case of sports book betting, these still-frame, video or other moving graphical images may display actual real-time, delayed or archived sports events or sports events highlights of the sports events being bet on the handheld gaming or cellular phone devices of individual telephone account bettors 28.

Tote system 12 manages wagering system 10. Specifically, tote system 12 maintains databases, controls and accounts for the transactions with gateway 16, manages the wagers by collating pools from all sources and computing winnings, manages the wagering accounts by accounting for all debits and credits by account, and provides detailed statistics for disbursement of funds.

Tote system 12 includes multiple databases including a wager profile and control database, a liability database, am account bettor database, and a network profile and control database. With respect to the wager profile and control database, such database contains data relating to which wagers are currently in use and status of the wager. The wager definition hierarchy is as follows:
Wager Type;
Wager Rules Table;
Wager Definition; and
Wager Group.

Wager type defines a kind of wager, including such attributes as the number of selections in a bet, the number of wining positions to consider, and the method of matching winning positions to bet selections.

Wager rules table contains data relating to variations in the rules for a basic wager type which the operator may alter. These options include, for example, the percentages of sales which are allotted to the tiers of major and minor progressive pools and to commissions (take-outs), denomination of a basic wager and minimum payment levels.

In the wager definition database, data is stored to define each instance of a wager type upon which wagers can be placed. Attributes include, for example, wager type, wager rule table selections, current status such as “betting open”, “open time”, and “final close time”, and amounts in the bet pool.

The wager group database defines a set of races at a specific race track or set of race tracks in which a collection of wager types may be offered. Telephone bettors 28, using PSTN 24, local telephone switch 22, voice recognition unit 20, and gateway 16, are allowed to wager on wager groups defined in this database. There may be a network of regional tote systems 12 collating pools into one master system, for example, a host tote system 12.

The liability database contains several tables for the reporting of financial liabilities. These tables include commissions, cooperating industry entitlements, account payments, breakage, and minimum payments.

Commission: taxes and other fixed percentage of sales which are removed before determination of the pari-mutuel pool.

Cooperating industry entitlements: distributions to the racing industry or other such interest groups, such as race tracks, horse/dog owners, jockeys and horseman's groups.

Account payments: total amounts paid to winning patron's accounts and a history of such payments.

Breakage: if any of the price round-off is not distributed, the amounts, including separation of the regulated round-off and any higher actual round-off.

Minimum payments: if any minimum payments levels have been used, the amounts, including separation of the regulated minimum and any higher actual payments.

The account bettor database stores data unique to each patron that has established a wagering account with the race track operator, pari-mutuel gaming network administrator or other sportbook or casino gaming network administrator. The database contains patron information such as name, address, and social security number. The database is organized by account numbers assigned to individual patrons. Each patron is also assigned a personal identification number (PIN) to secure the account. The account bettor database also stores the account balance, all wager transaction history, and all deposit and withdrawal transaction history.

The network profile and control database contains tables which defines the communications network. The network is a hierarchy of nodes, which is set forth below:
Gateway;
Voice recognition unit; and
Video/Visual-graphic game server.

Gateway 16 contains intermediate nodes for line multiplexing and protocol conversion. Voice recognition unit 20, connected to gateway 16, is a set of terminal nodes. Video/Video-graphic game server 11, connected to gateway 16, is a set of terminal nodes. Configuration of the nodes is under direct control of the system operator. Each voice recognition unit 20 includes 24 terminal nodes to gateway 16, video/visual-graphic game server 11 and tote system 12.

Gateway 16 also includes a database of personal information by account number. Personal information includes the prompt level, most frequent track, most frequent bet type, and number of times the patron has logged on. Personal information is used by the speech recognition engine to favor tracks and bet types often wagered by a patron.

The above-described gaming system 10 can be utilized in connection with many different types of events such as horse races, dog races, jai alai games. In addition, system 10 can be utilized in convection with other types of events. Importantly, system 10 supports and rewards the racing industry by reducing operational costs.

While the invention has been described in terms of various specific embodiments, those skilled in the art will recognize that the invention can be practiced with modification within the spirit and scope of the claims for application to other cellular phone-based game wagering, including but not limited to wagering on sports book games (baseball, football, basketball, soccer, etc.) and wagering on electronic casino games (video poker, video blackjack, video roulette, etc.).

What is claimed is:

1. A system for pari-mutuel, sports book and electronic casino gang comprising:
a tote system;
a video or visual-graphic game server;
a gateway, and
at least one voice recognition unit communicatably connected to a public telephone network, each said voice recognition unit communicatably coupled to said tote system through said gateway, each said voice recognition unit configured to receive wagers from a bettor by bettor speech utterances, to authenticate the identity of bettor by voice-print of bettor speech utterances, to convert the bettor speech utterances into commands, and to transmit said commands to said tote system through said gateway with accompanying video or visual-graphic game data served to and displayed on a handheld or cellular phone-based gaming device.

2. A system in accordance with claim 1 wherein each said voice recognition unit is configured to receive responses from said tote system to said commands, convert said responses to audio messages and video or visual-graphic images, and transmit said audio messages and video/visual-graphic images to the bettor.

3. A system in accordance with claim 1 further comprising:
a first high speed network communicatably connecting said tote system, said video/visual-graphic game server, and said gateway; and
a second high speed network communicatably connecting said gateway, said video/visual-graphic game server and each said voice recognition unit
